(19) United States
(12) Patent Application Publication
(10) Pub. No.: US 2019/0262885 A1
(43) Pub. Date: Aug. 29, 2019

(54) ELECTROMAGNETIC HAMMER DEVICE FOR THE MECHANICAL TREATMENT OF MATERIALS AND METHOD OF USE THEREOF

(71) Applicant: Stylianos Mores, Glyfada Attikis (GR)

(72) Inventor: Stylianos Mores, Glyfada Attikis (GR)

(21) Appl. No.: 16/309,146

(22) PCT Filed: Jun. 13, 2016
(86) PCT No.: PCT/GR2016/000028

§ 371 Date: Dec. 12, 2018

(51) Int. Cl. B21D 26/14; B23P 9/04; B24B 39/06; C21D 7/04

(52) U.S. Cl. CPC B21D 26/14; C21D 7/04; B24B 39/06; B23P 9/04

(57) ABSTRACT

An electromagnetic hammer device adapted to provide non-contact mechanical treatment of a material in planar items, cylindrical items, or tubular items including a conductor provided along a predetermined path within the material being treated and being supplied with a first pulsed current and a second linearly configured conductor or V-shaped conductor or conductive tube lined on top of conductor and being supplied with a second pulsed current, a layer of insulating material being lined intermediately between the first and second conductors. The simultaneous application of the first and second pulsed currents in the same direction results in exerting tensile forces onto the material and application of the currents in opposite directions results in exerting compressive forces therein. A pair of auxiliary conductors is preferably provided in each side of the second conductor, which provides adjustment of the angle in which the tensile or compressive forces are applied. A method for the mechanical treatment of a material using the hammer device.

### TECHNICAL FIELD

The present invention relates to a device and a method for the mechanical treatment of conductive and non-conductive surfaces including impact treatment, cyclic deformation, surface polishing, oxide removal, electromagnetic forming and electromagnetic welding by tensile and compressive stresses with the ability of adjusting the direction and the amplitude of the applied force vector. The device and method can also be used for non-destructive determination of the stress tensor distribution in materials subject to treatment.

### BACKGROUND ART

Mechanical treatment is used for tailoring the mechanical properties of a material subject to treatment with a scope of obtaining an approved profile of stress tensor distribution thereof. Such treatment has been historically performed mainly by thermal techniques as illustrated for example in U.S. Pat. Nos. 5,108,520 and in 3,480,486. Heating the material with consequent annealing (stress relief) or quenching (rapid cooling) methods, may result in reaching the desired levels of stress tensor distribution. One particular heat treatment method is the inductive heating with certain advantages in terms of time and contactless operation as disclosed in U.S. Pat. No. 2,446,202. The non-contact ability is the main advantage of these thermal techniques while their major disadvantage is the large uncertainty of the stress tensor distribution after the thermal treatment.

Apart from thermal treatment, mechanical methods have recently been developed and implemented in industrial applications. Ultrasonic Impact Treatment, as for example illustrated in U.S. Pat. No. 6,171,415, Laser Peening as for example illustrated in U.S. Pat. Nos. 4,937,421 and in 6,410,884 and Low Plasticity Burnishing as for example illustrated in U.S. Pat. No. 5,826,453, are the currently most widely accepted processes, which by introducing a certain amount of plastic deformation, produce a level of residual stress so as to improve damage tolerance and fatigue or stress-corrosion performance. The main advantage of all these techniques is their ability to precisely control the local surface stress tensor distribution, while their main disadvantages are the extensive time needed for such treatment and the requirement of a contacting means of treatment in some applications thereof.

Regarding cyclic deformation by the imposition of cyclic stresses in order to provide defect healing and microstructural strengthening, as for example in [Zhang-Jie Wang et al, Cyclic deformation leads to defect healing and strengthening of small-volume metal crystals, PNAS, 3, 112, 44, pp 13502-13507, 2015], poses the requirement of a method and a device for performing such treatment in an industrial scale.

As far as surface polishing and oxide removal is concerned, most treatments involve the implementation of dangerous chemicals and ultrasonic vibrations. The combination of ultrasonic, heat, and cleaning solutions is usually the preferred strategy. These applications present several disadvantages such as the necessity for tanks (in which the process takes place) and the use of solvents (subject to Health & Safety limitations). Aqueous solutions are also used, nevertheless are far less efficient.

Apart from the above, an electromagnetic hammer device has currently been used in an electromagnetic forming operation, as by way of example is illustrated in U.S. Pat. No. 3,426,564 and in an electromagnetic welding operation as by way of example is illustrated in U.S. Pat. No. 8,668,802. These electromagnetic hammer devices have employed the transmission of a pulsed electric current through a conductor (e.g. a solenoid) that is provided around the material subject to treatment, thereby giving rise to an inductive counter-acting response within the material. However, such an electromagnetic hammer device of the prior art can perform only a few mechanical treatment processes such as those referred to hereinabove since it might only supply compressive forces onto the material subject to treatment in a single direction, i.e. perpendicularly onto the material. Moreover, this electromagnetic hammer device requires excessive amounts of energy due to the substantially inferior magnitude of the inductive current within the material as compared to the current being supplied at the exterior thereof that eventually leads to the requirement of enhanced supply of current in order to obtain an adequate magnitude of the induced current and therefore be capable to properly perform such an electromagnetic forming or welding process.

Furthermore, none of the devices of the prior art provides for the non-destructive inspection of complex geometries and novel materials, e.g. sandwich structures that have always been a challenge, leading to new techniques based on laser-induced resonant frequencies, thus determining characteristic signatures of healthy structures. Possible defects alter or destroy the expected frequency signatures, leading to their detection. The excitation is offered by lasers which add great cost to the process.

### SUMMARY OF THE INVENTION

Thus, the object of the present invention is to develop an electromagnetic hammer device for performing non-contact mechanical treatment of conductive and non-conductive surfaces, wherein such device and method may be universally applied to perform mechanical treatment operations of all kinds including impact treatment, cyclic deformation, surface polishing, oxide removal, electromagnetic forming and electromagnetic welding, as well as to perform measurement of the stress tensor distribution, the device being adapted to deliver both tensile and/or compressive forces with the ability of adjusting the direction and the amplitude of the applied force vector in a faster, better and cheaper way than any of the devices and methods of the prior art.

The electromagnetic hammer device of the invention adapted to provide mechanical treatment of a material comprises a first conductor arranged to transmit pulsed current through a predetermined path within the material subject to treatment and a second conductor lined on top of said first conductor, wherein said first conductor is supplied with a first pulsed current (I₁) and said second conductor is supplied with a second pulsed current (I₂), a layer of insulating material of a thickness (t) lined intermediately between said first and second conductor, wherein a simultaneous application of said first and second pulsed currents in the same direction results in applying a tensile force and exerting a pull effect onto the material subject to treatment and application of said first and second pulsed currents in opposite directions results in applying a compressive force and exerting a push effect onto the material subject to treatment, said force (F) being exerted perpendicularly onto the material subject to treatment and provided by:

$$\frac{F}{L} = 2 {μμ}_{0} \frac{{I}_{1} {I}_{2}}{t}$$

where (L) stands for the length of the predetermined path within the material subject to treatment whereupon the force is applied, (μ) is the relative permeability of said layer of insulating material and (μ₀) is the vacuum permeability.

According to one preferred embodiment of the invention, the electromagnetic hammer is adapted to provide mechanical treatment of a linear strip or planar surface segment of the material subject to treatment, whereby the second conductor is configured as a longitudinal strip having a length and a width equivalent or smaller than a length and width of the linear strip or planar surface segment of the material subject to treatment.

According to another preferred embodiment of the invention the electromagnetic hammer is adapted to provide mechanical treatment of incremental volumes of the material subject to treatment, whereby the second conductor is a V-shaped conductor and therefore the device is adapted to provide a mechanical treatment, such treatment being sequentially performed in incremental volumes of selected spots necessitating the mechanical treatment in the material subject to treatment.

According to further embodiments of the invention a pair of auxiliary conductors configured as longitudinal strips or as V-shaped conductors is provided on each side of the second conductor that is correspondingly configured as longitudinal strips or as V-shaped conductor, such auxiliary conductors providing the ability of exerting forces onto the material subject to treatment at selected angular directions.

Further embodiments disclose use of the electromagnetic hammer device of the invention in performing a desired mechanical treatment in a cylindrical or tubular material subject to treatment.

In accordance with another embodiment of the invention the electromagnetic hammer is adapted to provide mechanical treatment of linear strips or planar areas or incremental volumes of a non-conductive material subject to treatment, whereby the non-conductive material subject to treatment is covered by a layer of a conductive material adapted to receive the abovementioned first conductor and be covered by a film of insulating material, thereafter the second conductor being provided above the film of insulating material in a direction parallel to the underlying first conductor.

Finally, the same electromagnetic hammer device may be used to monitor and provide measurement of the stress tensor distribution in materials of all kinds.

### DESCRIPTION OF THE DRAWINGS

Benefits and advantages of the present invention will become apparent after a careful reading of the detailed description with appropriate reference to the accompanying drawings.

FIG. 1 illustrates a first preferred embodiment of the electromagnetic hammer device of the invention adapted to provide mechanical treatment of a linear strip or planar surface and of the volume underlying the same, of a conductive material subject to such treatment through application of tensile or compressive forces, exerted perpendicularly thereupon.

FIG. 2 illustrates another preferred embodiment of the electromagnetic hammer device of the invention adapted to provide mechanical treatment of a linear strip or planar surface and of the volume underlying the same of a conductive material subject to such treatment through applying tensile or compressive forces, which are being exerted thereupon at appropriately selected angular directions.

FIG. 3 depicts another preferred embodiment of the electromagnetic hammer device of the invention adapted to provide mechanical treatment of incremental volumes of a linear strip or planar surface through the application of tensile or compressive forces, exerted perpendicularly thereupon.

FIG. 4 shows another preferred embodiment of the electromagnetic hammer device of the invention adapted to provide mechanical treatment of incremental areas of a linear strip or planar surface through the application of tensile or compressive forces, which are being exerted thereupon at appropriately selected angular directions.

FIG. 5 presents another preferred embodiment of the electromagnetic hammer device of the invention adapted to provide mechanical treatment of a volume underlying the entire circumference of a conductive cylinder subject to treatment through application of tensile or compressive forces exerted longitudinally along the entire circumference thereof.

FIG. 6 presents another preferred embodiment of the electromagnetic hammer device of the invention adapted to provide mechanical treatment in a conductive tube.

FIG. 7 illustrates a preferred embodiment of the electromagnetic hammer device of the invention adapted, to provide mechanical treatment of a linear strip or planar surface of a non-conductive material subject to such treatment.

### DETAILED DESCRIPTION OF THE INVENTION

The invention will hereinafter be presented with reference to the illustrative embodiments shown in the accompanying drawings, wherein are disclosed devices for applying different modes of stresses on the material subject to treatment.

The main object of the invention is to disclose an electromagnetic hammer device for applying tensile and/or compressive forces on the material to be treated, with the ability to act thereupon at appropriately selected angular directions.

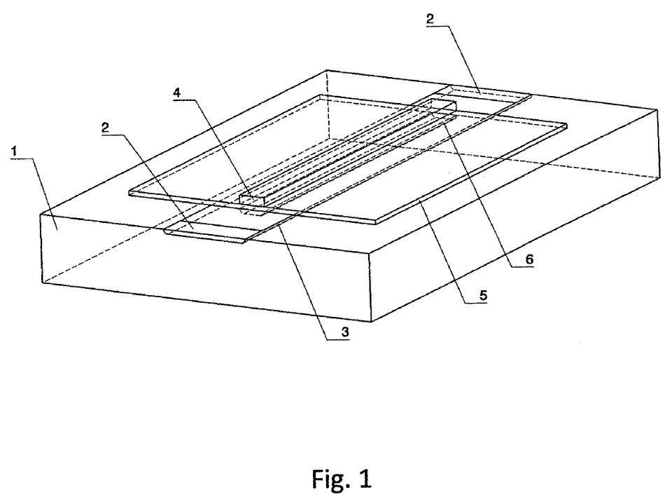

In accordance with a first preferred embodiment of the invention the electromagnetic hammer device is adapted to provide mechanical treatment of a linear strip or a planar surface and of the volume underlying the same and determined by the skin effect of a conductive material subject to such treatment through applying tensile or compressive forces, exerted perpendicularly thereupon. In this respect, as shown in FIG. 1, a first pulsed electric current is transmitted along a first electric conductor 2 being depicted with two terminals thereof located at the longitudinally extending ends of a linear strip or a planar surface segment 3 of the conductive material subject to treatment 1, such treatment being imposed by the skin effect caused by the pulsed electric current. A second electric conductor 4 is lined on top of the linear strip or planar surface segment 3 of the conductive material subject to treatment and in a direction parallel to the latter with a relatively thin layer of insulating material 5 positioned intermediately between the linear strip or planar surface segment 3 and the electric conductor 4. In accordance with one preferred embodiment of the invention the aforementioned insulating material 5 takes the form of an insulating film having appropriate dimensions for covering the linear strip or planar surface segment 3 of the material subject to treatment 1, whilst in accordance with another preferred embodiment, the insulating material 5 might take the form of an insulating coating of the electric conductor 4.

The electromagnetic hammer device shown in FIG. 1 operates through the supply of the abovementioned first pulsed electric current along the first electric conductor 2, i.e. longitudinally along the linear strip or planar surface segment 3 of the conductive material subject to treatment 1 and the simultaneous supply of a second pulsed electric current through the electric conductor 4 superimposed on top of the linear strip or planar surface segment 3, wherein the part of the linear strip or planar surface segment 3 below the electric conductor 4 is the mechanically treated volume 6 pertaining to the skin effect of the conductive material subject to treatment 1, whereby application of the aforementioned first and second pulsed currents in the same direction results in applying tensile forces, i.e. a pull effect, onto the mechanically treated volume 6 of the conductive material subject to treatment 1, whereas application of the aforementioned first and second pulsed currents in opposite directions results in applying compressive forces, i.e. a push effect, onto the mechanically treated volume 6 of the conductive material subject to treatment 1. With the electromagnetic hammer device of the hereinabove described embodiment shown in FIG. 1, the tensile or compressive forces are being exerted perpendicularly onto the mechanically treated volume 6 pertaining to the skin effect of the conductive material subject to treatment 1. It is evident that in order to provide a desired mechanical treatment in the overall volume underlying the linear strip or planar surface segment 3 of the conductive material subject to treatment 1, the second conductor must either have the length and width of this linear strip or planar surface segment 3 or it must be appropriately displaced in a transverse and/or longitudinal direction so as to perform the desired mechanical treatment in the overall linear strip or planar surface segment 3 of the conductive material subject to treatment 1.

The parameters of the transmitted pulsed electric current, including frequency, duty cycle, period and amplitude can be controlled. In this way, the depth of the mechanically treated volume 6 pertaining to the skin effect of the conductive material subject to treatment 1 can be determined by controlling the frequency bandwidth of the first pulsed electric current supplied to the first conductor 2 that is arranged to pass through the linear strip or planar surface segment 3 of the conductive material subject to treatment 1. Thus if, in accordance with a preferred embodiment, the electromagnetic hammer device of the invention is provided with means of controlling the frequency bandwidth of the pulsed electric current passing through the linear strip or planar surface segment 3 of the conductive material subject to treatment 1, the effective depth of the linear strip or planar surface segment 3 of the conductive material subject to treatment 1 can be appropriately regulated, wherein, in particular as the frequency bandwidth is increased, the effective depth of the mechanically treated volume 6 pertaining to the skin effect is decreased and vice versa. It is herein noted that the duration of the action of the electromagnetic hammer on the mechanically treated volume 6 is determined by the period of simultaneous transmission of the abovementioned first and second pulsed electric currents through the mechanically treated volume 6 of the conductive material subject to treatment 1.

The mechanically treated volume 6, subject to treatment, where pulsed electric current passes, is covered by a thin insulating film 5 of a thickness t. Thus, the tensile or compressive force F acting on the mechanically treated volume 6 follows Ampere's law and is therefore provided by the following formula:

$$\frac{F}{L} = 2 {μμ}_{0} \frac{{I}_{1} {I}_{2}}{t} \qquad ( 1 )$$

where L stands for the length of the mechanically treated volume 6 whereupon the force is applied, μ and μ₀ are the relative permeability of the insulating means 5 and the vacuum permeability respectively and I₁, I₂, t stand for the aforementioned first and second pulsed currents and their distance t (thickness of the insulating means 5) respectively.

It is herein noted that force F is amplified if the insulating film 5 is magnetic with a magnetic permeability μ>1.

In case that currents I₁ and I₂ are of an equal amplitude I, force F becomes:

$$\frac{F}{L} = 2 {μμ}_{0} \frac{{I}^{2}}{t} \qquad ( 2 )$$

The sign of the force F indicates the character of the force being applied, i.e. it is an indication of such force being either tensile or compressive resulting from the aforementioned first and second currents being supplied in the same and in the opposite direction respectively.

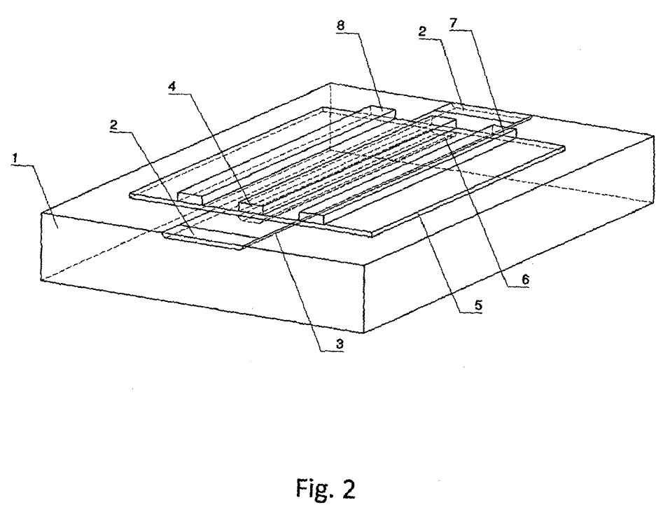

In accordance with a further preferred embodiment, the electromagnetic hammer device of the invention is further provided with a pair of auxiliary conductors 7 and 8 as illustrated in FIG. 2, such conductors 7 and 8 being positioned in parallel directions on either side of electric conductor 4 of the device. The supply of a third and fourth pulsed electric current in the aforementioned conductors 7 and 8 respectively provides a capacity of controlling the angle in which the aforementioned tensile or compressive forces are being applied onto the surface of the material subject to treatment. It is herein noted that, if instead of an insulating film 5 being lined in between the linear strip or planar surface segment 3 and the electric conductor 4, an insulating coating is employed around the electric conductor 4, it is evident that an analogous coating will be employed around the auxiliary conductors 7 and 8.

The auxiliary conductors 7 and 8 depicted in FIG. 2 are also being supplied with a third and a fourth pulsed current respectively, which is synchronized with the electric pulsed current transmitted through the linear strip or planar surface segment 3 and the electric conductor 4, thereby providing additional forces acting along with the force being generated between the linear strip or planar surface segment 3 and the electric conductor 4. A resultant force is thereby obtained that can be controlled to be directed at any angle from −90 to +90 degrees with respect to the force passing through the conductor 4 and acting perpendicularly onto the linear strip or planar surface segment 3 and therefore to generate tensile or compressive forces, which are being exerted onto the mechanically treated volume 6 at appropriately selected angular directions. By way of example, as the magnitude of the pulsed current is increased in the auxiliary conductor 7 and it is decreased in the auxiliary conductor 8, the resultant force tends to be inclined at an angle (x) towards the side of conductor 7 and vice versa. In case that no pulsed current is transmitted through the conductor 4, and the currents transmitted through the auxiliary conductors 7 and 8 are opposite in direction, the resultant force is on plane, offering the ability of surface polishing and treatment.

Furthermore, if the pulsed currents in the auxiliary conductors 7 and 8 are supplied in a direction opposing the current of the electric conductor 4, the width of the area corresponding to the mechanically treated volume 6 is narrowed.

In this way, a non-contact push-pull multidirectional electromagnetic hammer is provided that can be used for impact or cyclic deformation treatment.

In conclusion, the electromagnetic hammer arrangement of FIGS. 1 and 2 can be used for various types of mechanical treatment, applicable on either an area or a narrow strip (simulating a line), with the ability of controlling the amplitude and direction of the resultant, tensile or compressive, force acting on the volume subject to treatment.

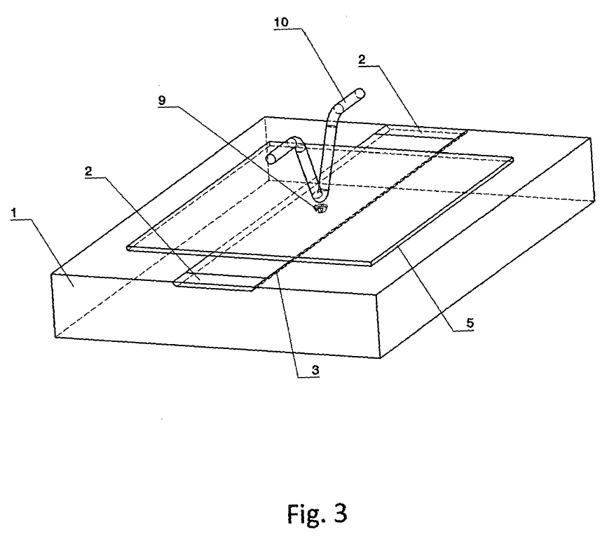

A further preferred embodiment of the electromagnetic hammer device of the invention appropriate for providing the desired effect onto an area under treatment is depicted in FIG. 3, in which an incremental volume 9 subject to treatment being part of a conductive material subject to treatment 1 and pertaining also to the skin effect is covered by a thin insulating film 5, with a V-shaped conductor 10 being on top of the thin insulating film 5. Incremental tensile or compressive forces are generated on the incremental volume 9 below the V-shaped conductor 10 by the pulsed currents passing through the incremental volume 9 and the V-shaped conductor 10. In accordance with this preferred embodiment, a mechanical treatment is being sequentially performed in incremental volumes 9 of selected spots necessitating such mechanical treatment in the material subject to treatment 1. A relatively thin layer of insulating material 5 is positioned intermediately between the conductive material subject to treatment 1 and the V-shaped conductor 10 or the latter may alternatively be coated by a thin insulating film 5.

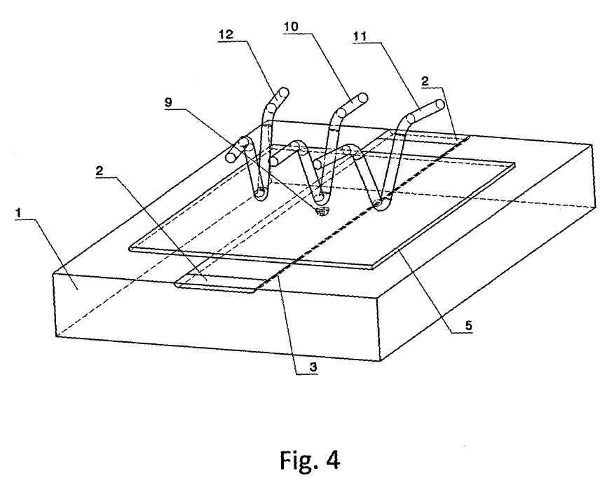

FIG. 4 depicts the preferred embodiment of FIG. 3, with the additional ability of tuning the angle and the amplitude of the resultant force on the surface of the volume subject to treatment through providing two further auxiliary V-shaped conductors 11 and 12, each one at one side of the V-shaped conductor 10 and being adapted to rotate at any angle onto the surface of the material subject to treatment, whereby such an arrangement is capable of tuning the amplitude and the angle of the resultant tensile or compressive force exerted onto the surface of the conductive material subject to treatment, wherein the angular direction of the resultant force can vary within a range of 360° all around a solid with a center at the incremental volume 9 subject to treatment by means of rotating the two auxiliary V-shaped conductors 11 and 12 on the surface of the conductive material subject to treatment 1. Mechanical treatment is provided by pulsed electric current passing through the incremental volume subject to treatment 9, the V-shaped conductor 10 and two auxiliary V-shaped conductors 11 and 12. Also in this case, if no pulsed current is transmitted through the V-shaped conductor 10, and the currents transmitted through the auxiliary V-shaped conductors 11 and 12 are opposite in direction, the resultant force is on plane, offering the ability of surface polishing and treatment.

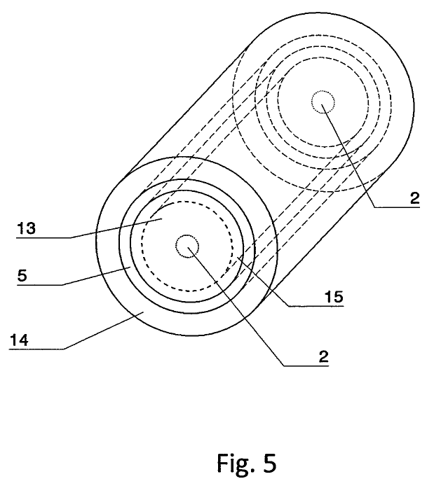

Another preferred application of such impact or cyclic deformation treatment refers to the treatment of steady-state conductive cylinders. FIG. 5 illustrates this type of operation. The cylinder subject to treatment 13 is covered by a thin insulating film 5 which in turn is covered by a conductive tube 14. According to this set-up, conductive elements with cylindrical shape can be processed by impact or cyclic deformation treatment by passing a first pulsed current through the whole cylinder 13 and a second pulsed current through the surrounding conductive tube 14 that is set on top of the thin insulating film 5 that covers the cylinder subject to treatment 13. In this way, tensile or compressive forces are applied throughout the infinitesimal volume 15 (skin effect) of the cylinder subject to treatment 13. These forces are proportional to the product of the applied pulsed currents and inversely proportional to the thickness of the thin insulating film. An excessive amount of transmitted pulsed current may result in heavy deformation of the surface of the cylinder subject to treatment, resulting even in surface polishing.

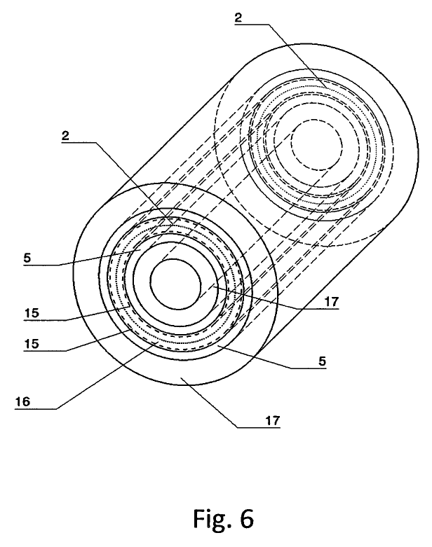

Another preferred application of such impact or cyclic deformation treatment refers to the treatment of steady-state conductive tubes. FIG. 6 illustrates this type of operation. The tube subject to treatment 16 is interiorly and exteriorly covered by a first and a second thin insulating film 5. A first conductive tube 17 is provided interiorly to the first insulating film 5 and a second conductive tube 17 is provided exteriorly to the second insulating film 5 respectively. According to this set-up, both the interior and the exterior circumference of the conductive tube subject to treatment 16 can be processed by impact or cyclic deformation treatment. To provide this effect a first pulsed current is passed through the conductor 2 of the entire tube subject to treatment 16 and a second pulsed current passes through the first conductive tube 17 that is positioned in the interior of the tube subject to treatment 16 and through the second conductive tube 17 being positioned in the exterior of the tube subject to treatment 16. In this way, tensile or compressive forces are applied throughout the infinitesimal volumes 15 of the tube subject to treatment 16. The forces being applied are again proportional to the product of the applied pulsed currents and inversely proportional to the thickness of the thin insulating film. Again an excessive amount of transmitted pulsed current may result in heavy deformation of the surface of the cylinder subject to treatment, resulting even in surface polishing.

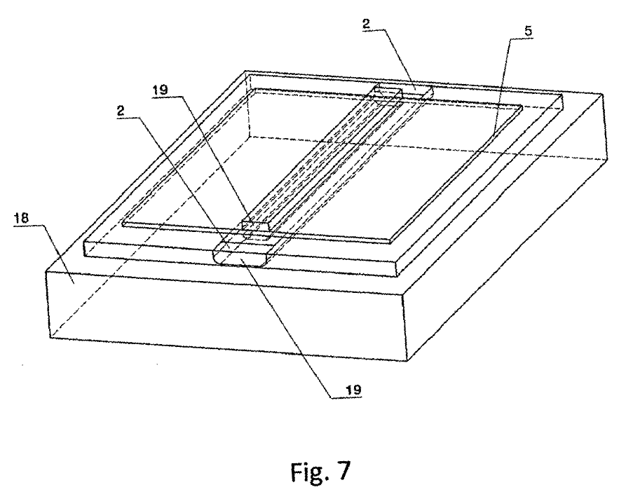

Mechanical treatment with the electromagnetic hammer of the invention can also be performed in a non-conductive material 18, such as that shown in FIG. 7, wherein a linear strip or a planar surface of the latter is covered by a pair of conductive linear strips or planar surface segments 19, wherein the aforementioned conductive linear strips or planar surface segments 19 are separated by a thin insulating film 5.

The electromagnetic hammer device shown in FIG. 7 operates through the transmission of pulsed current in the two conductive linear strips or planar surface segments 19, where in this case pulsed current is transmitted in opposite directions in the two conductive linear strips or planar surface segments 19, thereby exerting compressive forces on the surface of the non-conductive material 18, which thus result in impact and/or cyclic deformation on the non-conductive material 18. Pulsed current might also be transmitted in the same direction in the two conductive linear strips or planar surface segments 19, thereby exerting tensile forces on the surface of the non-conductive material 18, however in this case the linear strip or planar surface segment 19 adjacent to the surface of the non-conductive material 18 has to be fixedly adhered thereupon by means of an appropriate adhesive.

The method can be used for oxide removal due to the ability to generate local force excess; additionally, electromagnetic forming and electromagnetic welding can be substantially improved with the present electromagnetic hammer device wherein a pulsed current passes through the material subject to treatment. Various planar, cylindrical or tubular surfaces of conductive materials can successfully be subjected to necessary mechanical treatment using the electromagnetic hammer of the invention. Appropriate mechanical treatment can also be provided in non-conductive materials by means of covering them with conductive elements. In this particular case, only compressive stresses can be applied on the surface of the material subject to treatment, but if such conductive materials are fixedly adhered thereupon tensile stresses might also be applied.

The described method and devices can be used for the non-contact mechanical treatment of conductive and non-conductive surfaces including impact treatment, cyclic deformation, surface polishing, as well as contactless and efficient removal of surface oxidation due to the aforementioned generated tensile and/or compressive forces with the ability of adjusting the direction and the amplitude of the applied force vector.

The electromagnetic hammer device of the invention may also be employed to measure the stress tensor distribution in the material subject to treatment, thereby the device being adapted to operate as a stress sensing element, by means of generating considerably smaller tensile and/or compressive forces, which, instead of treating the material, generate elastic waves, their shape and size determining the stress level of the corresponding area of elastic wave generation, propagation and detection.

All herein described embodiments of the electromagnetic hammer device of the invention may alternatively be employed to suit specific configurations of materials subjected to mechanical treatments, such as impact treatment, cyclic deformation, electromagnetic forming and electromagnetic welding, whilst mechanical treatments, such as surface polishing, oxide removal and mechanical machining are mainly being obtained with the electromagnetic hammer devices depicted in FIGS. 1, 2, 3 and 4. Nondestructive testing is being obtained with any of the hereinabove described embodiments in combination with appropriate sensing and data acquisition devices.

An all-inclusive electromagnetic hammer device is provided that comprises conductors being configured in the form of linear strips and V-shaped conductors including auxiliary conductors in the form of linear strips and V-shaped conductors, wherein a case-specific arrangement of conductors is used to provide the aforementioned all-inclusive types of mechanical treatment in all types of planar or curved surfaces, such all-inclusive electromagnetic hammer device further comprising a power supply means and a computer provided with the appropriate software for arranging the frequency bandwidth and the magnitude and direction of the pulsed currents being supplied in each particular case to serve the scope of the intended mechanical treatment.

Accordingly a method for the mechanical treatment of conductive materials is provided that includes the steps of:

supplying a first pulsed electric current in a first conductor (2) through a predetermined path within the material (1, 13, 16) subject to treatment, and

supplying a second electric current in a second conductor (4, 10, 14, 17) lined on top of a layer of insulating material (5) separating said first conductor (2) from said second conductor (4, 10, 14, 17), wherein a simultaneous application of said first and second pulsed currents in the same direction results in applying a tensile force and exerting a pull effect onto the material (1, 13, 16) subject to treatment and application of said first and second pulsed currents in opposite directions results in applying a compressive force and exerting a push effect onto the material (1, 13, 16) subject to treatment, said force (F) being exerted perpendicularly onto the material subject to treatment.

In accordance with a further embodiment a further step of supplying a third and a fourth pulsed electric current in a third and fourth conductor (7, 8) or (11, 12) disposed on each side of the second conductor (4) or (10) respectively, thereby providing an enhanced resultant force being exerted onto the material subject to treatment and a capacity of controlling the angle in which this resultant force is being applied onto the material subject to treatment through varying the magnitude of the abovementioned third and fourth pulsed electric currents.

What is claimed is:

1. An electromagnetic hammer device adapted to provide mechanical treatment of a material, comprising a first conductor arranged to pass through a predetermined path within the material subject to treatment, said first conductor being supplied with a first pulsed current (I₁) and a second conductor lined on top of said first conductor and being supplied with a second pulsed current (I₂), a layer of insulating material of a thickness (t) lined intermediately between said first and second conductors and, wherein a simultaneous application of said first and second pulsed currents in the same direction results in applying a tensile force and exerting a pull effect onto the material subject to treatment and application of said first and second pulsed currents in opposite directions results in applying a compressive force and exerting a push effect onto the material subject to treatment, said force (F) being exerted perpendicularly onto the material subject to treatment and provided by:
$$\frac{F}{L} = 2 {μμ}_{0} \frac{{I}_{1} {I}_{2}}{t}$$
where (L) stands for the length of the predetermined path within the material subject to treatment whereupon the force is applied, (μ) is the relative permeability of said layer of insulating material and (μ₀) is the vacuum permeability.

2. The electromagnetic hammer device according to claim 1, wherein the material subject to treatment is a generally planar item with a volume underlying a linear strip or planar surface segment of said generally planar item wherein said first conductor is lined and said second conductor is lined on top and in a direction parallel to said first conductor and configured in the form of a longitudinal strip having a length and a width equivalent or smaller than a length and width of said linear strip or planar surface segment of said material subject to treatment, whereby a mechanical treatment is being respectively performed in a single phase of treatment in the overall linear strip or planar surface segment or in a plurality of phases of treatment each in a portion of the linear strip or planar surface segment determined by the smaller length and width of said second conductor.

3. The electromagnetic hammer device according to claim 1, wherein the material subject to treatment is a generally planar item with an incremental volume underlying a linear strip or planar surface segment thereof, said first conductor being lined within said linear strip or planar surface segment and said second conductor is a V-shaped conductor positioned on top of said first conductor, whereby a mechanical treatment is being sequentially performed in incremental volumes of selected spots necessitating said mechanical treatment in said generally planar item of the material subject to treatment.

4. The electromagnetic hammer device according to claim 3, further comprising a pair of auxiliary conductors being positioned on either side of said second conductor respectively, said auxiliary conductors being supplied with a third and a fourth pulsed electric current respectively, thereby providing an enhanced resultant force being exerted onto said volume or said incremental volume underlying a linear strip or planar surface segment of said generally planar item of the material subject to treatment and a capacity of controlling the angle in which said resultant force is being applied onto the generally planar item of the material subject to treatment through varying the magnitude of said third and fourth pulsed electric currents.

5. The electromagnetic hammer device according to claim 4, wherein said pair of auxiliary conductors are oriented in a direction parallel to said second conductor and said resultant force being obtained from simultaneously acting said second, third and fourth pulsed electric currents being controlled to be directed at any angle from −90 to +90 degrees with respect to the force being exerted perpendicularly through said second conductor onto the material subject to treatment.

6. The electromagnetic hammer device according to claim 4, wherein said pair of auxiliary conductors are oriented in a direction parallel to said second conductor and said resultant force being obtained from simultaneously acting said second, third and fourth pulsed electric currents being controlled to be directed at any angle within a range of 360° all around a solid evolving on either side of the linear strip or planar surface segment or with a center at the incremental volume of the material subject to treatment by means of rotating said auxiliary conductors onto the surface of the material subject to treatment.

7. The electromagnetic hammer device according to claim 1, wherein the material subject to treatment is a cylindrical item with an infinitesimal volume underlying the circumference thereof, said cylindrical item being covered by an insulating film, said first conductor being adapted to receive said first pulsed current being arranged to pass within said cylindrical item and said second conductor being adapted to receive said second pulsed current being a conductive tube positioned on top of said insulating film that covers said cylindrical item.

8. The electromagnetic hammer device according to claim 1, wherein the material subject to treatment is a tubular item with infinitesimal volumes pertaining to a skin effect underlying an interior and an exterior circumference thereof, a first insulating film being provided interiorly said tubular item and a second insulating film being provided exteriorly said tubular item, said second conductor being a conductive tube, a first conductive tube being provided interiorly to the first insulating film and a second conductive tube being provided exteriorly to the second insulating film respectively, said first conductor being adapted to receive said first pulsed current being arranged to pass within said tubular item and said first and second conductive tubes being adapted to receive said second pulsed current, wherein supply of said first pulsed current in said first conductor and simultaneous supply of said second pulsed current within said first and second conductive tubes results in application of tensile or compressive forces throughout the infinitesimal volumes in the interior and the exterior circumference of the tubular item subject to treatment.

9. The electromagnetic hammer device according to claim 2, wherein said insulating material is an insulating film having appropriate dimensions for covering said first conductor and separating it from said second conductor and said auxiliary conductors respectively.

10. The electromagnetic hammer device according to claim 2, wherein said insulating material is an insulating coating thoroughly covering said second conductor and said auxiliary conductors respectively.

11. The electromagnetic hammer device according to claim 1, further comprising means of controlling the frequency bandwidth of said first pulsed current (I₁) passing through the predetermined path within the material, thereby providing regulation of an effective depth of the material subject to mechanical treatment with said electromagnetic hammer device.

12. A method for the mechanical treatment of conductive materials including the steps of:
supplying a first pulsed electric current in a first conductor through a predetermined path within the material subject to treatment; and
supplying a second electric current in a second conductor lined on top of a layer of insulating material separating said first conductor from said second conductor,
wherein the mechanical treatment realized with a simultaneous application of said first and second pulsed currents in the same direction results in applying a tensile force and exerting a pull effect onto the material subject to treatment and application of the first and second pulsed currents in opposite directions results in applying a compressive force and exerting a push effect onto the material subject to treatment, the force (F) being proportional to the product of the applied first and second pulsed currents and inversely proportional to the thickness of the layer of the insulating material and being exerted perpendicularly onto the material subject to treatment.

13. The method of claim 12, further including the steps of:
supplying a third and a fourth pulsed electric current in a third and fourth conductor disposed on each side of said second conductor, thereby providing an enhanced resultant force being exerted onto said material subject to treatment and a capacity of controlling the angle in which the resultant force is being applied onto the material subject to treatment through varying the magnitude of the third and fourth pulsed electric currents.
